(19) United States
(12) Patent Application Publication
(10) Pub. No.: US 2023/0322000 A1
(43) Pub. Date: Oct. 12, 2023

(54) INKJET RECORDING APPARATUS

(71) Applicant: KYOCERA Document Solutions Inc., Osaka (JP)

(72) Inventor: Naoto MIYAKOSHI, Osaka (JP)

(73) Assignee: KYOCERA Document Solutions Inc., Osaka (JP)

(21) Appl. No.: 18/189,730

(22) Filed: Mar. 24, 2023

(30) Foreign Application Priority Data
Mar. 31, 2022 (JP) 2022-058430

(51) Int. Cl. B41J 11/00

(52) U.S. Cl. CPC B41J 11/0085; B41J 11/00222; B41J 11/007

(57) ABSTRACT

An inkjet recording apparatus includes a conveyance belt, a sheet suction portion, a sheet conveyance portion, a recording portion, a suction roller, and an exhaust fan. The suction roller, at an upstream side of the recording portion with respect to a sheet conveyance direction, brings the sheet into contact with the outer circumferential surface of the conveyance belt. The exhaust fan, at an upstream side of the suction roller with respect to the sheet conveyance direction, sucks air existing over the conveyance belt. The exhaust fan causes air existing over the conveyance belt to flow through intervals between adjacent ones of roller portions of the suction roller in the sheet width direction, and thereby sucks and discharges air in a direction away from the conveyance belt.

### INCORPORATION BY REFERENCE

This application is based on and claims the benefit of priority from Japanese Patent Application No. 2022-058430 filed on Mar. 31, 2022, the contents of which are hereby incorporated by reference.

### BACKGROUND

The present disclosure relates to an inkjet recording apparatus.

Inkjet recording apparatuses that record an image by ejecting ink from nozzles provided in recording heads are capable of recording a high-definition image and thus have been widely used as recording apparatuses such as facsimile machines, copiers, and printers. Such inkjet recording apparatuses suffer a problem that paper dust generated from paper sheets used as a recording medium may become stuck in a nozzle to cause poor ejection from the nozzle, resulting in poor image quality.

### SUMMARY

According to one aspect of the present disclosure, an inkjet recording apparatus includes a sheet conveyance portion, a recording portion, a suction roller, and an exhaust fan. The sheet conveyance portion includes a conveyance belt and a sheet suction portion, and conveys a sheet. The conveyance belt is endless, and a plurality of ventilation holes are formed therein. The sheet suction portion is disposed inside the conveyance belt, includes a suction fan that sucks air through the ventilation holes, and holds a sheet by suction on an outer circumferential surface of the conveyance belt. The recording portion is disposed opposite the outer circumferential surface of the conveyance belt, includes a recording head from which ink is ejected, and records an image by ejecting ink onto the sheet held by suction on the conveyance belt. The suction roller is disposed opposite such part of the outer circumferential surface of the conveyance belt as is located upstream of the recording portion with respect to a sheet conveyance direction, at an upstream-side end part of the sheet suction portion, and brings the sheet into contact with the outer circumferential surface of the conveyance belt. The exhaust fan is disposed adjacent to an upstream side of the suction roller with respect to the sheet conveyance direction, and sucks air existing over the conveyance belt. The suction roller includes a rotation shaft and a plurality of roller portions. The rotation shaft extends in a sheet width direction perpendicular to the sheet conveyance direction. The plurality of roller portions are arrayed on the rotation shaft at intervals along the sheet width direction so as to contact the sheet, and rotate about the rotation shaft. The exhaust fan causes air existing over the conveyance belt to pass through the intervals between adjacent ones of the roller portions in the sheet width direction, and thereby sucks and discharges the air in a direction away from the conveyance belt.

### BRIEF DESCRIPTION OF THE DRAWINGS

FIG. 1 is a schematic sectional front view of an inkjet recording apparatus according to an embodiment of the present disclosure.

FIG. 2 is a top view of a recording portion and the vicinity thereof in the inkjet recording apparatus shown in FIG. 1.

FIG. 3 is a partial sectional front view of the recording portion and the vicinity thereof in the inkjet recording apparatus shown in FIG. 1.

FIG. 4 is a partial sectional front view showing an upstream side, in a sheet conveyance direction, of the recording portion and the vicinity thereof shown in FIG. 3.

FIG. 5 is a top view of a suction roller shown in FIG. 4.

FIG. 6 is a top view of a suction roller according to a modified example.

### DETAILED DESCRIPTION

Embodiments of the present disclosure will be described below with reference to the accompanying drawings. The present disclosure, however, is not limited to what is specifically described below.

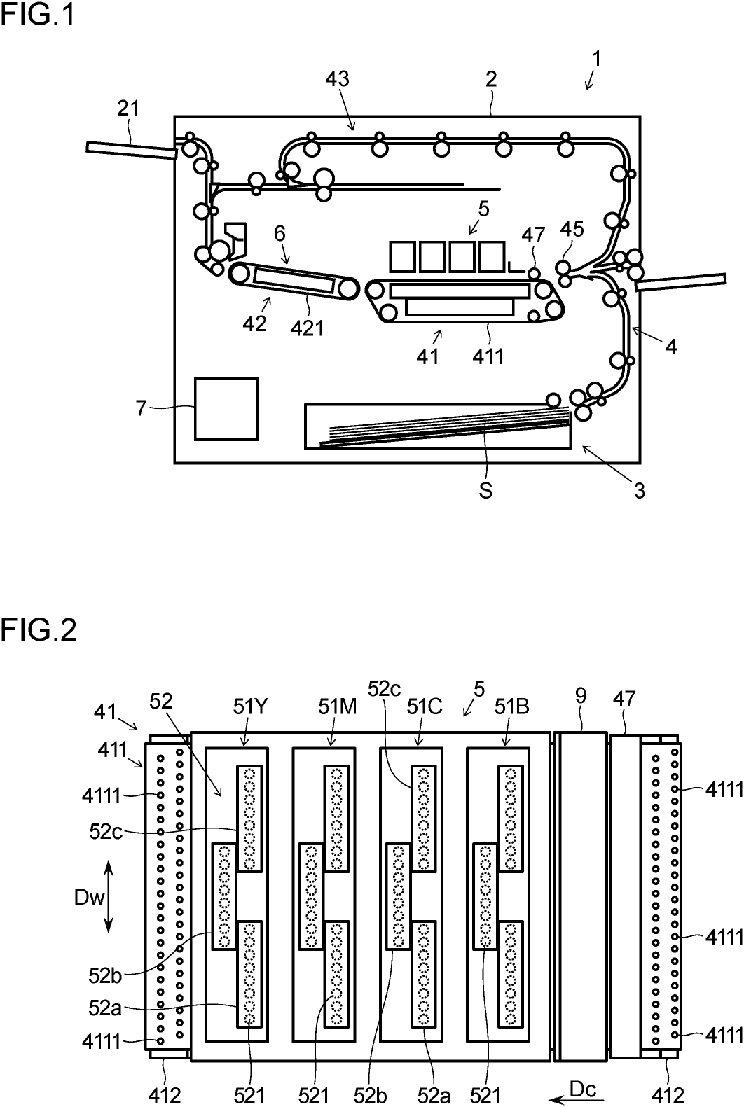

FIG. 1 is a schematic sectional front view of an inkjet recording apparatus 1 according to an embodiment. FIG. 2 is a top view of a recording portion 5 and the vicinity thereof in the inkjet recording apparatus 1 shown in FIG. 1. The inkjet recording apparatus 1 is an inkjet recording printer, for example. As shown in FIGS. 1 and 2, the inkjet recording apparatus 1 includes an apparatus main body 2, a sheet feed portion 3, a sheet conveyance portion 4, the recording portion 5, a drying portion 6, and a control portion 7.

The sheet feed portion 3 is disposed in a lower part of the apparatus main body 2, for example. The sheet feed portion 3 stores a plurality of sheets (of a recording medium) S, and, during image recording, feeds out the sheets S separately one by one. The sheet conveyance portion 4 conveys a sheet S fed out from the sheet feed portion 3 to the recording portion 5 and then to the drying portion 6, and further discharges the sheet S, having been subjected to recording and drying, into a sheet discharge portion 21. In a case where double-sided printing is to be performed, the sheet conveyance portion 4 sorts the sheet S having been subjected to recording and drying on its first side toward a reversing conveyance portion 43, where the conveyance direction of the sheet S is switched and the sheet S is reversed upside down, and then the sheet S is once again conveyed to the recording portion 5 and the drying portion 6.

The sheet conveyance portion 4 includes a first belt conveyance portion 41 and a second belt conveyance portion 42. The first belt conveyance portion 41 and the second belt conveyance portion 42 convey a sheet S by holding it by suction on outer circumferential surfaces (upper surfaces) of a first conveyance belt 411 and a second conveyance belt 421, respectively, which are both endless belts. The first belt conveyance portion 41 is disposed below the recording portion 5 to convey a sheet S. The second belt conveyance portion 42 is located downstream of the first belt conveyance portion 41 in a sheet conveyance direction Dc, and is disposed in the drying portion 6 to convey a sheet S.

The recording portion 5 is disposed opposite the outer circumferential surface (the upper surface) of the first conveyance belt 411. That is, the recording portion 5 is disposed so as to be opposite a sheet S that is conveyed in a state held by suction on the outer circumferential surface (the upper surface) of the first conveyance belt 411. The recording portion 5 is disposed above the first conveyance belt 411 at a predetermined interval therefrom.

The recording portion 5 holds head units 51B, 51C, 51M, and 51Y corresponding to four colors of black, cyan, magenta, and yellow, respectively. The head units 51B, 51C, 51M, and 51Y are disposed side by side along the sheet conveyance direction Dc such that their longitudinal direction is parallel to a sheet width direction Dw perpendicular to the sheet conveyance direction Dc. The four head units 51B, 51C, 51M, and 51Y have basically the same structure, and thus, in the following descriptions, the suffixes “B”, “C”, “M”, and “Y” indicating colors may be omitted unless specific distinction is necessary.

The head units 51 for the different colors each include a line recording head 52 for inkjet recording. Each of the head units 51 for the different colors includes a plurality of (for example, three (52a, 52b, 52c)) recording heads arrayed in a staggered formation along the sheet width direction Dw.

Each of the recording heads 52 has a plurality of ink ejection nozzles 521 in a bottom part thereof. The plurality of ink ejection nozzles 521 are disposed one adjacent another along the sheet width direction Dw, and ink can be ejected therefrom over an entire recording region on a sheet S. That is, each of the recording heads 52 includes the plurality of ink ejection nozzles 521 that eject ink onto a sheet S. The recording portion 5 causes the head units 51B, 51C, 51M, and 51Y for the four colors to sequentially eject ink from their respective recording heads 52 onto a sheet S conveyed in a state held by suction on the first conveyance belt 411, and thereby records a full-color or monochrome image on the sheet S.

The drying portion 6 is disposed downstream of the recording portion 5 in the sheet conveyance direction Dc, and is provided with the second belt conveyance portion 42. A sheet S on which an ink image has been recorded in the recording portion 5 is conveyed through the drying portion 6 in a state held by suction on the second conveyance belt 421, during which period the ink is dried.

The control portion 7 includes a CPU, a storage portion, and other electronic circuits and parts (of which none is illustrated). The CPU controls operations of various components provided in the inkjet recording apparatus 1 based on a control program and control data stored in the storage portion, and thereby performs processes related to functions of the inkjet recording apparatus 1. The sheet feed portion 3, the sheet conveyance portion 4, the recording portion 5, and the drying portion 6 each individually receive instructions from the control portion 7, and cooperate with each other to perform recording on a sheet S.

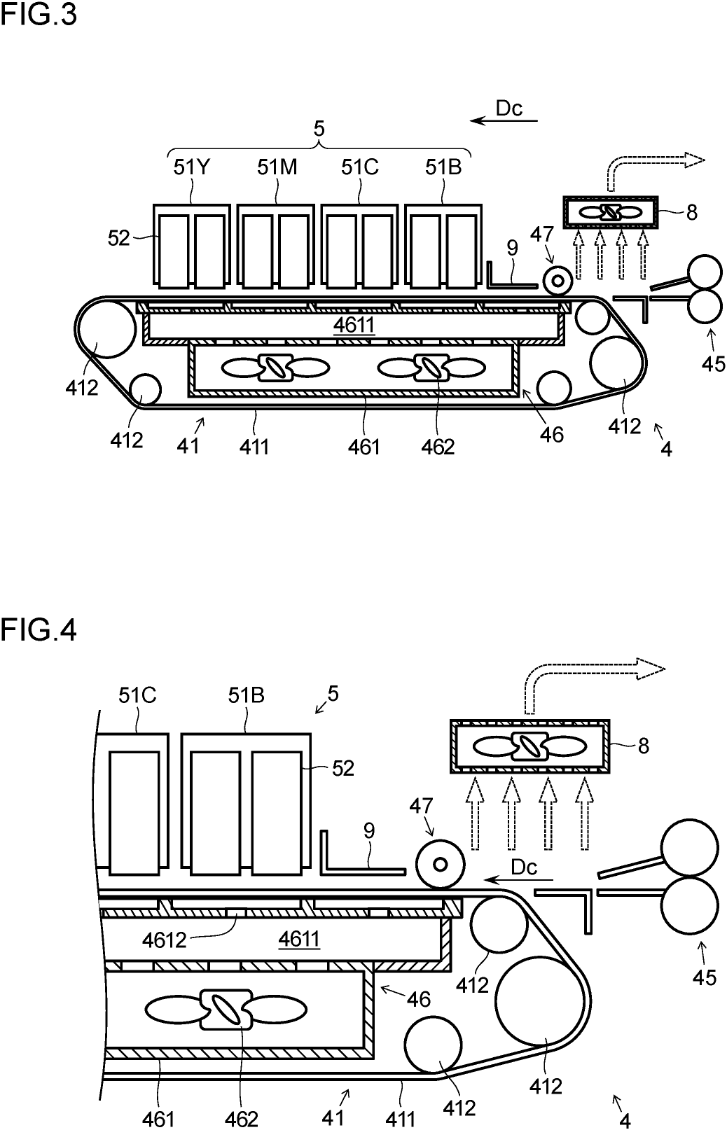

FIG. 3 is a partial sectional front view of the recording portion 5 and the vicinity thereof in the inkjet recording apparatus 1 shown in FIG. 1. FIG. 4 is a partial sectional front view showing an upstream side, in a sheet conveyance direction, of the recording portion 5 and the vicinity thereof shown in FIG. 3. FIG. 5 is a top view of a suction roller 47 shown in FIG. 4. In FIGS. 3, 4, and 5, white arrows outlined with broken lines indicate air flows generated when a later-described exhaust fan 8 is driven and directions of the air flows.

As shown in FIGS. 3 and 4, the sheet conveyance portion 4 further includes a pair of registration rollers 45, a sheet suction portion 46, and a suction roller 47.

The pair of registration rollers 45 are disposed downstream of the sheet feed portion 3 in the sheet conveyance direction Dc. Immediately close to a downstream side of the pair of registration rollers 45 in the sheet conveyance direction Dc, the first belt conveyance portion 41 and the recording portion 5 are disposed. Each roller in the pair of registration rollers 45 is supported to be rotatable about a rotation shaft extending along the sheet width direction Dw (see FIG. 2).

A sheet S fed out from the sheet feed portion 3 passes through the sheet conveyance portion 4 to reach where the pair of registration rollers 45 are located. The control portion 7 controls the pair of registration rollers 45 to correct skewed feeding of the sheet S and also to feed out the sheet S toward the first belt conveyance portion 41 with timing coordinated with timing of an ink ejection operation executed by the recording portion 5.

The sheet conveyance portion 4 includes a registration sensor (unillustrated). The registration sensor is disposed immediately close to an upstream side of the pair of registration rollers 45 in the sheet conveyance direction Dc. The registration sensor detects a sheet S when the sheet reaches the pair of registration rollers 45 after being fed out from the sheet feed portion 3. The control portion 7 receives, from the registration sensor, a detection signal indicating detection of the sheet S, and based on the detection signal, the control portion 7 controls rotation of the pair of registration rollers 45.

The first belt conveyance portion 41 is disposed below the recording portion 5. The first belt conveyance portion 41 holds a sheet S on its upper surface by suction, and conveys the sheet S along the sheet conveyance direction Dc. The first belt conveyance portion 41 includes the first conveyance belt 411 and a plurality of rollers 412.

The first conveyance belt 411 is an endless belt, and is stretched by the plurality of rollers 412, which are disposed inside the first conveyance belt 411. The rollers 412 are disposed inside the first conveyance belt 411, and are supported to be rotatable about rotation shafts extending along the sheet width direction Dw (see FIG. 2). Among the plurality of rollers 412, one is a driving roller, which causes the first conveyance belt 411 to rotate such that an upper side thereof moves in the sheet conveyance direction Dc.

As shown in FIG. 2, the first conveyance belt 411 has a plurality of ventilation holes 4111. The ventilation holes 4111 penetrate through the first conveyance belt 411 from inside through outside. The outer circumferential surface of the first conveyance belt 411 is a sheet conveyance surface. A sheet S, in a state held on the sheet conveyance surface of the first conveyance belt 411, is conveyed to a position opposite the recording heads 52.

The sheet suction portion 46 is disposed inside the first conveyance belt 411. More specifically, the sheet suction portion 46 is located in an upper part inside the first conveyance belt 411, and is disposed opposite an upper-side part of the inner circumferential surface (a back side) of the first conveyance belt 411, the upper-side part of the inner circumferential surface of the first conveyance belt 411 being an opposite surface of the sheet conveyance surface of the first conveyance belt 411. The sheet suction portion 46 includes a housing 461 and an air suction fan 462.

The housing 461 is formed as a substantially rectangular-parallelepiped box body, for example, and includes a suction chamber 4611 that is surrounded by walls. The suction chamber 4611 is disposed below the head units 51B, 51C, 51M and 51Y so as to be opposite the upper-side part of the inner circumferential surface (the back side) of the first conveyance belt 411, which is the opposite surface of the sheet conveyance surface of the first conveyance belt 411, over a region from a position upstream of the head unit 51B for black in the sheet conveyance direction Dc to the head unit 51Y for yellow.

The housing 461 has a plurality of air suction holes 4612 that are formed in an upper surface thereof, the upper surface being disposed over the suction chamber 4611. The plurality of air suction holes 4612 penetrate through the upper surface of the housing 461 in an up-down direction.

The air suction fan 462 is disposed at a position that is inside the housing 461 and is under the suction chamber 4611. When the air suction fan 462 is driven, the sheet suction portion 46 sucks air through the air suction holes 4612 and the ventilation holes 4111 (see FIG. 2), and thereby holds a sheet S by suction on the sheet conveyance surface of the first conveyance belt 411.

The suction roller 47 is disposed opposite such part of the sheet conveyance surface of the first conveyance belt 411 as is located upstream of the recording portion 5 in the sheet conveyance direction Dc, at an upstream-side end part of the sheet suction portion 46. In other words, the suction roller 47 is disposed above the upstream-side end part of the housing 461 in the sheet conveyance direction Dc, with the first conveyance belt 411 therebetween. The suction roller 47 is supported to be rotatable about a rotation shaft extending along the sheet width direction Dw (see FIG. 2).

An outer circumferential surface of the suction roller 47 contacts the sheet conveyance surface of the first conveyance belt 411. By contacting the first conveyance belt 411, for example, the suction roller 47 is caused to rotate following rotation of the first conveyance belt 411. The suction roller 47 brings a sheet S conveyed thereto from the pair of registration rollers 45 into contact with the sheet conveyance surface of the first conveyance belt 411.

As shown in FIG. 5, the suction roller 47 includes a rotation shaft 471 and a plurality of roller portions 472. The rotation shaft 471 extends in the sheet width direction Dw, and is supported to be rotatable about an axis line thereof. To the rotation shaft 471, the plurality of roller portions 472 are fixed. The plurality of roller portions 472 are arrayed on the rotation shaft 471 at intervals along the sheet width direction Dw. The plurality of roller portions 472 come into contact with the sheet S conveyed on the first conveyance belt 411, and rotate about the rotation shaft 471.

Further, the inkjet recording apparatus 1 includes the exhaust fan 8 shown in FIGS. 3 and 4. The exhaust fan 8 is disposed adjacent to an upstream side of the suction roller 47 in the sheet conveyance direction Dc. In other words, the exhaust fan 8 is disposed upstream of the sheet suction portion 46 in the sheet conveyance direction Dc. The exhaust fan 8 is disposed such that an air suction surface is opposite the sheet conveyance surface of the first conveyance belt 411, that is, opposite the sheet S conveyed on the first conveyance belt 411.

When driven, the exhaust fan 8 sucks air existing over the first conveyance belt 411. At this time, air existing over such part of the first conveyance belt 411 as is located downstream of the suction roller 47 in the sheet conveyance direction Dc is sucked by the exhaust fan 8 through the intervals between adjacent ones of the roller portions 472 in the sheet width direction Dw. That is, the exhaust fan 8 causes the air existing over the first conveyance belt 411 to pass through the intervals between adjacent ones of the roller portions 472 in the sheet width direction Dw, and thereby sucks and discharges the air in a direction away from the first conveyance belt 411.

According to the above structure, by the exhaust fan 8, which is disposed upstream of the sheet suction portion 46 in the sheet conveyance direction Dc, paper dust on the first conveyance belt 411 is sucked and discharged together with air. Thereby, it is possible to effectively remove paper dust generated from a sheet S while maintaining suitable sheet conveying performance.

Here, on an exhaust side of the exhaust fan 8, there is provided an exhaust duct (unillustrated) extending to an exterior wall of the apparatus main body 2, for example. Further, on a suction side of the exhaust fan 8 or inside the exhaust duct, there may be provided a filter (unillustrated) for trapping paper dust and the like included in the air sucked by the exhaust fan 8.

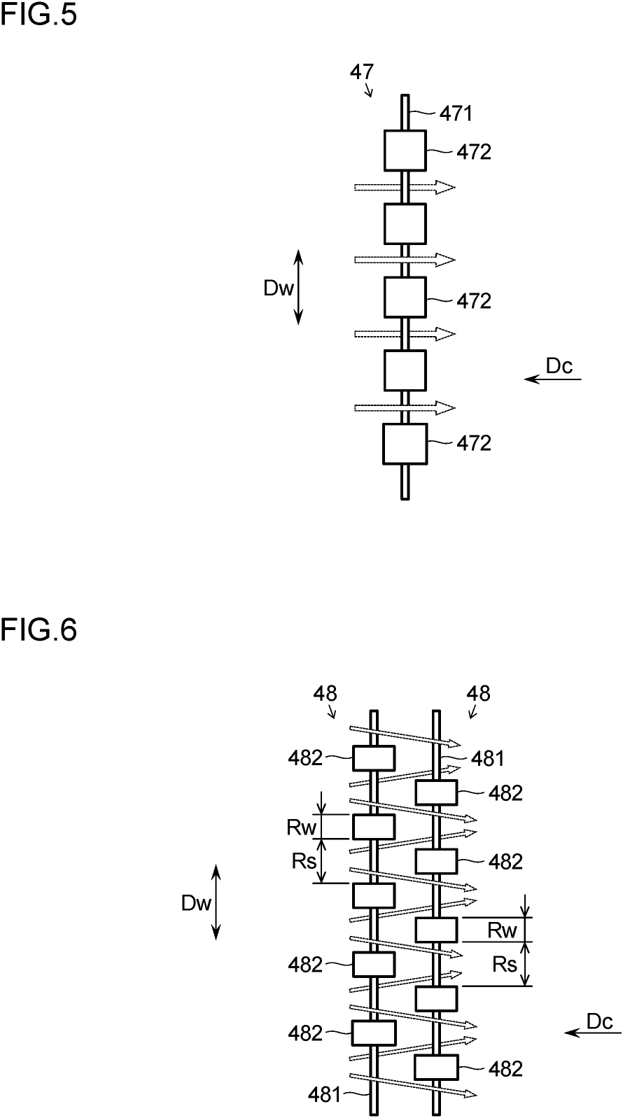

FIG. 6 is a top view of a suction roller 48 according to a modified example. In FIG. 6, white arrows outlined with broken lines indicate air flows generated when the exhaust fan 8 is driven and directions of the air flows.

As shown in FIG. 6, a sheet conveyance portion 4 of the modified example includes a plurality of suction rollers 48. In the present modified example, the sheet conveyance portion 4 includes two suction rollers 48. The two suction rollers 48 are disposed side by side in a row along the sheet conveyance direction Dc. These two suction rollers 48 are similar to the suction roller 47 shown is FIG. 4 in that they are disposed opposite such part of the sheet conveyance surface of the first conveyance belt 411 as is located upstream of the recording portion 5 in the sheet conveyance direction Dc, at an upstream-side end part of the sheet suction portion 46.

According to the above structure, it is possible to improve accuracy of contact of a sheet S with respect to the sheet conveyance surface of the first conveyance belt 411. Accordingly, it is possible to achieve improved sheet conveyance performance.

The two suction rollers 48 each include a rotation shaft 481 and a plurality of roller portions 482. In each of the suction rollers 48, intervals Rs between adjacent ones of the roller portions 482 in the sheet width direction Dw are wider than widths Rw of the roller portions 482. In the two suction rollers 48 disposed adjacent to each other in the sheet conveyance direction Dc, between adjacent ones of the roller portions 482 of one of the suction rollers 48 in the sheet width direction Dw, the roller portions 482 of the other of the suction rollers 48 are located.

According to this structure, it is possible to alternately arrange the roller portions 482 of one and the other of the two suction rollers 48 in the sheet width direction Dw, and to secure some space between the roller portions of one and the other of the two suction rollers 48. Thereby, it is possible to achieve improved sheet conveyance performance, and further to suppress excessive rise in suction resistance due to the exhaust fan 8.

Further, the inkjet recording apparatus 1 includes a plate portion 9 shown in FIGS. 3 and 4. The plate portion 9 is disposed opposite such part of the sheet conveyance surface of the first conveyance belt 411 as is located, in the sheet conveyance direction Dc, upstream of the recording portion 5 but downstream of the suction roller 47. In other words, the plate portion 9 is disposed above an upstream part of the housing 461 in the sheet conveyance direction Dc, with the first conveyance belt 411 therebetween. The plate portion 9 is disposed above the first conveyance belt 411 at a predetermined interval therefrom.

The plate portion 9 extends in the sheet conveyance direction Dc and in the sheet width direction Dw. The plate portion 9 extends in parallel with the sheet conveyance surface of the first conveyance belt 411, for example.

According to the above structure, it is possible to narrow an air flow path over the first conveyance belt 411, in the vicinity of the sheet conveyance surface. Accordingly, it is possible to increase speed of the air flows generated by the exhaust fan 8, and thus to effectively remove paper dust generated from a sheet S.

The plate portion 9 extends in the sheet conveyance direction Dc and the sheet width direction Dw, over an entire region between the recording portion 5 and the suction roller 47, for example. According to this structure, it is possible to further increase the speed of the air flows generated by the exhaust fan 8, and thus to further improve the effect of removing paper dust generated from a sheet S.

The above-described embodiments are by no means meant to limit the scope of the present disclosure, and various modifications can be made and implemented within the scope not departing from the gist of the present disclosure.

What is claimed is:

1. An inkjet recording apparatus, comprising:
a sheet conveyance portion that includes
a conveyance belt that is endless and in which a plurality of ventilation holes are formed, and
a sheet suction portion that is disposed inside the conveyance belt, that includes an air suction fan that sucks air through the ventilation holes, and that holds a sheet by suction on an outer circumferential surface of the conveyance belt, and
that conveys the sheet;
a recording portion that is disposed opposite the outer circumferential surface of the conveyance belt, that includes a recording head from which ink is ejected, and that records an image by ejecting ink onto the sheet held by suction on the conveyance belt;
a suction roller that is disposed opposite such part of the outer circumferential surface of the conveyance belt as is located upstream of the recording portion with respect to a sheet conveyance direction, at an upstream-side end part of the sheet suction portion, and that brings the sheet into contact with the outer circumferential surface of the conveyance belt; and
an exhaust fan that is disposed adjacent to an upstream side of the suction roller with respect to the sheet conveyance direction and that sucks air existing over the conveyance belt, wherein
the suction roller includes
a rotation shaft that extends in a sheet width direction perpendicular to the sheet conveyance direction and
a plurality of roller portions that are arrayed on the rotation shaft at intervals along the sheet width direction so as to contact the sheet, and that rotate about the rotation shaft, and
the exhaust fan causes air existing over the conveyance belt to pass through the intervals between adjacent ones of the roller portions in the sheet width direction, and thereby sucks and discharges the air in a direction away from the conveyance belt.

2. The inkjet recording apparatus according to claim 1, wherein
the suction roller includes a plurality of suction rollers that are disposed side by side in a row along the sheet conveyance direction.

3. The inkjet recording apparatus according to claim 2, wherein
in each of the suction rollers, intervals between adjacent ones of the roller portions are wider than widths of the roller portions, and
in adjacent ones of the suction rollers in the sheet conveyance direction, between adjacent ones of the roller portions in the sheet width direction of one of the adjacent ones of the suction rollers, the roller portions of an other of the adjacent ones of the suction rollers are located.

4. The inkjet recording apparatus according to claim 1, further comprising:
a plate portion that is disposed opposite such part of the outer circumferential surface of the conveyance belt as is located upstream of the recording portion but downstream of the suction roller with respect to the sheet conveyance direction, and that extends in the sheet conveyance direction and in the sheet width direction.

5. The inkjet recording apparatus according to claim 4, wherein
the plate portion extends over an entire region in the sheet conveyance direction and in the sheet width direction between the recording portion and the suction roller.
